(19) United States
(12) Patent Application Publication
(10) Pub. No.: US 2017/0023125 A1
(43) Pub. Date: Jan. 26, 2017

(54) SECURING AND/OR TENSIONING OF A PLANET SHAFT

(71) Applicants: ZF Friedrichshafen AG, Friedrichshafen (DE); ZF WIND POWER ANTWERPEN N.V., Lommel (BE)

(72) Inventor: Gerhard DIEKHANS, Bocholt (DE)

(21) Appl. No.: 15/039,056

(22) PCT Filed: Nov. 18, 2014
(86) PCT No.: PCT/EP2014/074830

§ 371 Date: May 25, 2016

(30) Foreign Application Priority Data
Dec. 18, 2013 (DE) 10 2013 226 522.0

(51) Int. Cl. F16H 57/08

(52) U.S. Cl. CPC F16H 57/082; F16H 2057/085; F03D 15/00

(57) ABSTRACT

A member for axially fixing and/or tensioning a planetary bolt, in particular a planetary bolt of the planetary gear stage of the transmission of a wind turbine. Based on the idea of providing a screw joint for axially fixing and/or tensioning a planetary bolt in the immediate vicinity of a section of the planetary bolt which has a shoulder for the axial fixing and/or tensioning of planetary bearings. This enables short load paths between the planetary bearings and the screw joint and, consequently, high rigidity.

This application is a National Stage completion of PCT/EP2014/074830 filed Nov. 18, 2014, which claims priority from German patent application serial no. 10 2013 226 522.0 filed Dec. 18, 2013.

### FIELD OF THE INVENTION

The invention concerns the axial fixing and/or tensioning of a planetary bolt, in particular a planetary bolt of the planetary gear stage of the transmission of a wind turbine.

### BACKGROUND OF THE INVENTION

In wind turbines the planetary bolts, also called planetary shafts, fulfill two main functions. On the one hand, the planetary bolts serve as the bearing seat for the planetary gearwheel bearings. For each planetary gearwheel at least two bearings are usually used. These have to be fixed in the axial direction. Particularly when conical roller bearings are used, it is furthermore desirable to tension the bearing, i.e. to prestress the bearing in the axial direction, in order to avoid damage and increase the life of the bearing.

On the other hand, the planetary bolts fix the two halves of a planetary carrier relative to one another. Thus, the planetary bolts act to increase the rigidity and stability of the planetary carrier.

To be able to fulfill the functions described, the planetary bolts must be attached to the planetary carrier as firmly as possible. For that purpose it has been found suitable to form a press fit in which the planetary carrier is shrunk onto the planetary bolts. To do this the planetary carrier is first heated. The planetary bolts are then inserted into the hot planetary carrier. When the planetary carrier then cools, it shrinks onto the planetary bolts so that a press fit is formed between the planetary carrier and the planetary bolts.

So that the press fit between the planetary carrier and the planetary bolts can withstand higher loads, a tighter press fit with larger size differences between the planetary bolts and the planetary carrier is formed. However, this has disadvantages. Thus, before assembly the planetary carrier has to be heated more strongly. This brings the risk that assembly workers will suffer severe burns if they touch the planetary carrier. Furthermore, owing to the larger size differences the stresses present in the shrink-fitted planetary carrier are higher and this detracts from the load-bearing capacity and durability of the planetary carrier.

From the prior art solutions are known for improving the load-bearing capacity of planetary bolts in the axial direction. For example, the document US 2006/0293142 A1 discloses a clamping screw for the axial tensioning of a planetary bolt. The planetary bolt has an axially extending, through-going bore through which the clamping screw can be inserted. In the planetary carrier there is a thread into which the clamping screw can be screwed. The head of the clamping screw and the thread are then at two axially opposite ends of the planetary bolt, so that the clamping screw can exert a force on the planetary bolts in the direction of the thread.

A comparable solution is disclosed in the document U.S. Pat. No. 6,491,600 B1. Here however, the clamping screw is not screwed directly into the planetary carrier, but into a plate-shaped insert. The insert is located in a recess of the planetary carrier provided for it. Thus, in this case too the head of the clamping screw exerts a force on the planetary bolt in the direction of the thread.

The solutions described have certain disadvantages. Since the clamping screw passes in the longitudinal direction through the planetary bolt so that the screw head and the thread are arranged axially at opposite ends of the planetary bolt, the length of the clamping screw is determined by the geometry of the planetary bolt. As a result only very long clamping screws with a correspondingly low extension rigidity can be used. Consequently, the clamping screw has high compliance against loads in the axial direction. The result is that axial displacement of the planetary bolt cannot be effectively prevented.

Furthermore, to allow the clamping screw to pass through the planetary bolt a bore is needed. This reduces the load-bearing capacity of the bolt both against radially acting forces and against axial torsion.

### SUMMARY OF THE INVENTION

The purpose of the present invention is to enable fixing of a planetary bolt in the axial direction while avoiding the disadvantages inherent in the solutions known from the prior art.

The invention achieves this objective in accordance with the independent claim(s).

The common idea of the objects of the independent claim(s) described below is to provide a screw joint for the axial fixing and/or tensioning of the planetary bolt in the immediate vicinity of a section of the planetary bolt that comprises a shoulder for the axial fixing and/or tensioning of planetary bearings. This enables short load paths between the planetary bearings and the screw joint, and because of that, high rigidity.

A planetary bolt according to the invention, particularly a one-piece bolt, can be divided into two sections, a first section and a second section. The first section of the planetary bolt is designed to receive planetary bearings. This means in particular that the first section of the planetary bolt can fix the planetary bearings in the axial direction. For that purpose the first section of the planetary bolt has in each case a bearing seat for the planetary bearings. As the bearing seat, there is preferably at least one cylindrical portion of the first section onto which the inner ring of at least one of the planetary bearings can be pushed. Preferably, the entire first section of the planetary bolt is cylindrical.

The planetary bearings serve for the rotational mounting of a planetary gearwheel on the planetary bolt. The planetary gearwheel rotates coaxially with the planetary bolt. At least two planetary bearings, preferably exactly two bearings are provided. In particular, the invention is suitable for axially fixing and/or tensioning conical roller bearings.

The second section of the planetary bolt has a shoulder for axially fixing and/or tensioning the planetary bearings. The shoulder forms an annular surface that extends coaxially with the planetary bolt and is directed perpendicularly to the axis of symmetry of the planetary bolt and the rotational axis of the planetary gearwheel.

The planetary bearings are axially fixed and/or tensioned between the shoulder of the planetary bolt and a contact surface of the planetary carrier provided for the purpose. Both each individual planetary bearing and the planetary bearings relative to one another are axially fixed and/or tensioned.

Preferably, the shoulder is designed to be a contact surface with an inner ring of a first one of the planetary bearings. The shoulder can exert a force on the inner ring in a first direction. The inner ring of a second one of the planetary bearings can preferably come into contact with the planetary carrier, either directly, i.e. with a common contact surface between them, or indirectly, i.e. via an intermediate element. Correspondingly, the planetary carrier can exert a force on the inner ring of the second planetary bearing in a second direction opposite to the first direction.

In addition, means are preferably provided which enable the outer ring of the first planetary bearing and the outer ring of the second planetary bearing to be supported relative to one another. Such means may for example be an intermediate ring, or steps in the planetary gearwheel, and/or a further planetary bearing. Direct contact between the outer rings is also possible. Thus, the outer ring of the first of the planetary bearings can exert a force on the outer ring of the second planetary bearing in the first direction while the outer ring of the second planetary bearing exerts a reciprocal force on the outer ring of the first planetary bearing in the second direction.

According to the invention, the planetary bolt can be provided with at least one internal thread. This is shaped such that the second section of the planetary bolt has a run-in opening for the internal thread. The run-in opening is understood to be a preferably circular opening in the planetary bolt through which the internal thread is accessible. Thus, the internal thread is an internal thread tapped into the second section of the planetary bolt.

It is desirable to position the internal thread in such manner that the internal thread is accessible even in the fitted condition of the planetary bolt, i.e. when the planetary bolt has been fitted in a planetary carrier. In particular, it should be possible to screw into the internal thread a first means for axially fixing and/or tensioning the planetary bolt, to be described below, in the fitted condition of the planetary bolt.

According to the invention, instead of or in addition to the internal thread, the second section of the planetary bolt can have at least one external thread.

Regarding the positioning of the external thread, its accessibility in the fitted condition of the planetary bolt and its ability to be screwed together with the first means for axially fixing and/or tensioning the planetary bolt when the planetary bolt has been screwed in place, the same considerations mentioned above in connection with the internal thread apply, mutatis mutandis. Thus, it is desirable to position the external thread in such manner that even in the fitted condition of the planetary bolt, i.e. when the planetary bolt is in place on a planetary carrier, the outer external thread is accessible. In particular, it should be possible in the fitted condition of the planetary bolt to screw onto the external thread the first means for axially fixing and/or tensioning the planetary bolt.

According to the invention, the first means of the invention for axially fixing and/or tensioning the planetary bolt described above has at least one thread which can be screwed together with the internal or external thread of the planetary bolt. Thus, the thread of the means is designed such that it can form a matching thread pair with the internal or external thread o the planetary bolt.

The matching thread pair serves to exert the force required for axially fixing and/or tensioning the planetary bolt. Besides the thread pair, the shoulder of the planetary bolt is also involved in exerting the force. Both the shoulder and also the internal and/or external thread of the planetary bolt are in the second section of the planetary bolt. Thus, it is possible to arrange the shoulder of the planetary bolt and the internal and/or external thread of the planetary bolt, and therefore also the first means for axially fixing and/or tensioning the planetary bolt, spatially directly in proximity to one another. This results in a short load path and therefore high rigidity.

In a preferred embodiment, the first means for axially fixing and/or tensioning the planetary bolt is designed such that it can be braced against a locking ring or lamellar ring when the locking or lamellar ring is set into a groove in the planetary carrier. Thus, the planetary carrier has a groove. The groove preferably extends coaxially with the planetary bolt when the bolt is fitted in a through-going bore of the planetary carrier provided for fixing the planetary bolt.

For fixing and/or tensioning it against the locking or lamellar ring, the first means for axially fixing and/or tensioning the planetary bolt preferably has a surface with which it can be supported against the locking or lamellar ring. Thus, the first means for axially fixing and/or tensioning the planetary bolt can exert a force on the locking or lamellar ring in the second direction. This force can be produced in particular by rotating the thread pair, i.e. rotating the thread of the means for axially fixing and/or tensioning the planetary bolt relative to the internal and/or external thread of the planetary bolt. Then, a force in the first direction acts correspondingly on the thread pair and hence on the internal and/or external thread of the planetary bolt. Thus, the rotation described leads to tensioning of the planetary bolt.

It is also possible by rotating the thread pair to fix the planetary bolt in the axial direction so that desired bearing play is produced.

A planetary carrier according to the invention is provided with at least one through-going bore for introducing and fixing a planetary bolt. To fit the planetary bolt in the planetary carrier, the planetary bolt is introduced into the through-going bore. The through-going bore then fixes the planetary bolt at least in the radial direction. This is preferably done by a press fit in which the planetary carrier is shrunk onto the planetary bolt. The planetary carrier is first heated. When the planetary carrier then cools, it shrinks onto the planetary bolt so that a tight fit is formed between the planetary carrier and the planetary bolt.

According to the invention, the through-going bore of the planetary carrier of the invention has an internal thread. This is preferably coaxial with the axis of symmetry of the through-bore or the axis of symmetry of the planetary bolt introduced into the through-bore or the rotational axis of a planetary gearwheel mounted to rotate on the planetary bolt or its planetary bearings. Furthermore, the through-going bore preferably forms a cylindrical hollow space.

To axially fix and/or tension the planetary bolt, it has been found advantageous for the planetary bolt introduced into the through-going bore to not fill the through-going bore completely. Instead, the internal thread is located in the part of the through-going bore left free by the planetary bolt. This makes it possible to screw into the internal thread of the planetary carrier a second means according to the invention for axially fixing and/or tensioning the planetary bolt, once the planetary bolt has been introduced into the through-going bore. Correspondingly, the second means for axially fixing and/or tensioning the planetary bolt has at least an external thread which can be screwed together with the internal thread of the planetary carrier. Thus, the external thread and the internal thread of the planetary carrier can form a matching thread pair.

The second means for axially fixing and/or tensioning the planetary bolt also preferably has at least one contact surface for the planetary bolt. This contact surface brings about the axial fixing and/or tensioning of the planetary bolt when the planetary bolt is introduced into the planetary carrier and the second means for axially fixing and/or tensioning the planetary bolt is screwed into the through-going bore of the planetary carrier, i.e. the external thread of the means has been screwed together with the internal thread of the planetary carrier.

The contact surface is arranged so that the second means for axially fixing and/or tensioning the planetary bolt can exert a force acting in the first direction on the planetary bolt via the contact surface. In particular, a force acts at the contact surface in the first direction on the planetary bolt when the second means for axially fixing and/or tensioning the planetary bolt is braced by screwing into the through-going bore between the planetary carrier and the planetary bolt. A corresponding force in the second direction then acts via the thread pair upon the planetary carrier.

It is also possible by screwing the second means into the through-going bore, to selectively restrict the mobility of the planetary bolt in the axial direction and thereby to produce a desired bearing play.

A third means according to the invention for axially fixing and/or tensioning a planetary bolt has at least one internal thread. The internal thread is through-going, so that by screwing a screw into the internal thread the screw can be braced against the planetary bolt. The screw then exerts a force on the planetary bolt introduced into the planetary carrier, in the first direction.

A corresponding force in the second direction is exerted by the third means for axially fixing and/or tensioning the planetary bolt on a locking or lamellar ring set into a groove in the planetary carrier. Thus, the means for axially fixing and/or tensioning the planetary bolt is braced by rotating the screw in the internal thread against the locking or lamellar ring set into the groove.

Preferably, the groove extends inside a through-going bore of the type described above. Particularly preferably, the through-going bore and the groove are directed coaxially with one another. Thus, the groove extends in the circumferential direction around the symmetry axis of the through-bore or the planetary bolt introduced into the through-going bore or the rotational axis of a planetary gearwheel.

Rotation of the first or second means for axially fixing and/or tensioning the planetary bolt relative to the planetary bolt and/or relative to the planetary carrier, or rotation of the bracing screw against the planetary bolt relative to the third means for axially fixing and/or tensioning the planetary bolt, would have the result that the axial tensioning of the planetary bolt would be lost and/or the planetary bolt would be displaced in the axial direction. This in turn would result in a loss of the tensioning of the planetary bearings and/or a change of the bearing play. The latter can lead to bearing damage.

To achieve security against rotation, in a preferred embodiment the first, second and third means for axially fixing and/or tensioning the planetary bolt are provided with a through-going thread. Into this, a locking screw can be inserted. The locking screw is designed to prevent rotation of the means relative to the planetary bolt and/or relative to the planetary carrier, or rotation of the bracing screw relative to the planetary bolt and relative to the means. For that purpose the through-going thread is arranged so that the locking screw acts on the planetary bolt, on the planetary carrier or on the screw for bracing against the planetary bolt.

In the case of the first means for axially fixing and/or tensioning the planetary bolt, the locking screw preferably acts against the planetary bolt.

In the second means for axially fixing and/or tensioning the planetary bolt, it is also possible to orientate the through-going thread so that the locking screw acts upon the planetary bolt. When there is a press fit between the planetary bolt and the planetary carrier which is firm enough to secure the planetary bolt against rotating relative to the planetary carrier, this also secures the second means for axially fixing and/or tensioning the planetary bolt against rotating. In contrast, if rotation of the planetary bolt relative to the planetary carrier and thus rotation of the second means for axially fixing and/or tensioning cannot be excluded with sufficient certainty, the through-going thread is preferably designed so that the locking screw acts against the planetary carrier.

Alternatively the second means can be in the form of a locknut in order to prevent rotation.

In the case of the third means for axially fixing and/or tensioning the planetary bolt, the through-going thread is designed such that the locking screw acts upon the screw for bracing the third means for axially fixing and/or tensioning the planetary bolt.

### BRIEF DESCRIPTION OF THE DRAWINGS

The figures illustrate example embodiments of the inventions described below. Matching indexes in different figures denote the same, or functionally equivalent features.

In detail, the figures show:

FIG. 1: A first planetary bolt, with an external thread for screwing on an axial fixing means;

FIG. 2: A second planetary bolt, with an external thread for screwing on an axial fixing means;

FIG. 3: A planetary bolt with an internal thread for screwing in an axial fixing means;

FIG. 4: An axial fixing means for screwing into a planetary carrier; and

FIG. 5: An axial fixing means, for tensioning by means of a screw.

### DETAILED DESCRIPTION OF THE PREFERRED EMBODIMENTS

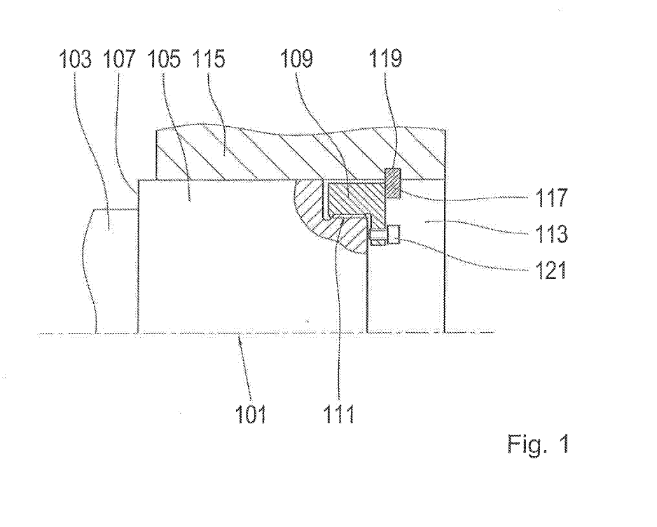

A planetary bolt 101 as in FIG. 1 has a first cylindrical section 103 and a second cylindrical section 105. The diameter of the second section 105 is larger than the diameter of the first section 103, so that a step with a shoulder 107 is formed, which serves for axially fixing the planetary bearing. On the side opposite this step in the axial direction the second section 105 has a further step on which the external thread is formed. An axial fixing means 109 has an internal thread which can be screwed together with the external thread of the planetary bolt 105, so that the internal thread of the axial fixing means 109 and the external thread of the planetary bolt 105 form a matching thread pair 111.

A recess 113 in a planetary carrier 115 in the form of a through-going bore serves for fixing the planetary bolt 101. For this, the planetary bolt 101 extends only partially into the recess 113 and so leaves part of the recess 113 free. In that part, besides the axial fixing means 109 there is a locking ring 117. The locking ring 117 is set into a groove 119 that extends coaxially with the planetary bolt 101, the axial fixing means 109 and the locking ring 117.

By rotating the axial fixing means 109 relative to the planetary bolt 101 the axial fixing means 109 can be braced against the locking ring 117. Correspondingly, this tensions the planetary bolt 101 against the axial fixing means 109 and consequently also braces the planetary bolt 101 against the locking ring 117. Ultimately, the planetary bolt 101 is tensioned against the planetary carrier 115.

In the axial fixing means 109 locking screws 121 are inserted. These are made pointed at their ends so that over a small area they can exert a high pressure on the planetary bolt 101 or the second section 105 of the planetary bolt 101. That prevents any rotation of the axial fixing means 109 relative to the planetary bolt 101.

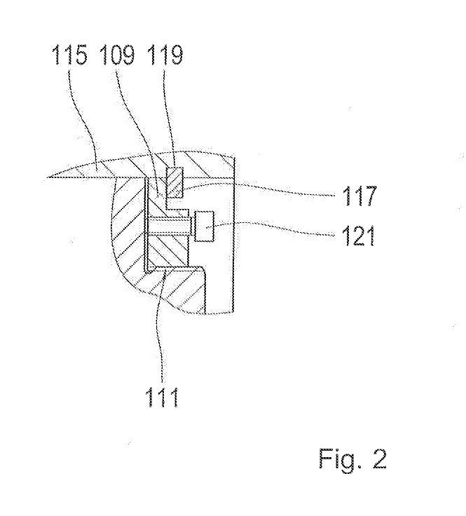

FIG. 2 shows a variant of the example embodiment illustrated in FIG. 1, in which in particular the positions of the locking screws 121 are different. In FIG. 2 the locking screws 121 are positioned in the axial direction between the thread pair 111 and the planetary carrier 115. However, a load path extends between the thread pair 111 and the locking ring 117. The locking screws 121 are in this load path. In contrast, in the example embodiment according to FIG. 1 the locking screws 121 are outside the load path, so that the axial fixing means 109 can be made more stable.

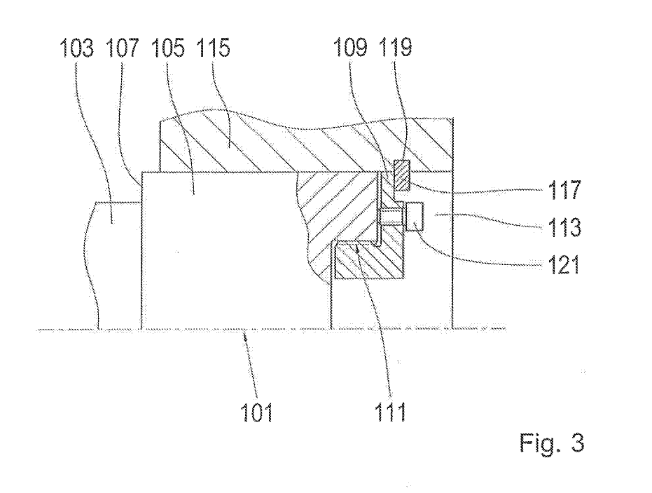

FIG. 3 shows an example embodiment in which the planetary bolt 101 has an internal thread, which forms the thread pair 111 with an external thread of the axial fixing means 109. As in the example embodiment of FIG. 2, in this case the locking screws 121 are in the load path between the thread pair 111 and the locking ring 117. Correspondingly, a version of the invention in accordance with FIG. 1 enables the design of a load-bearing axial fixing means 109.

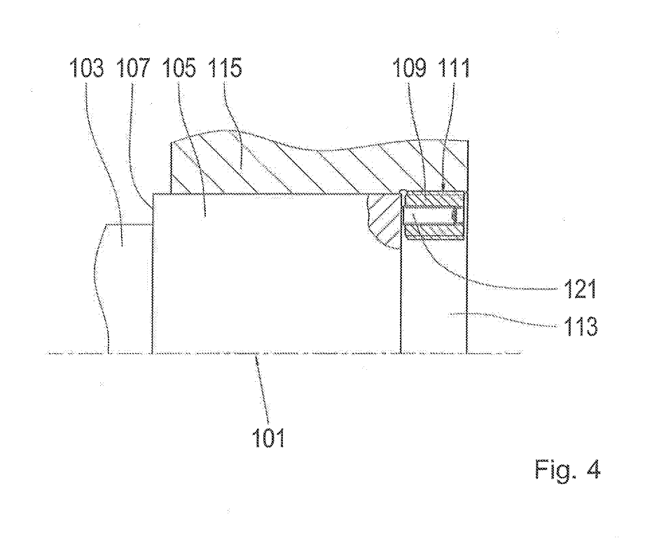

The axial fixing means shown in FIG. 4 is not screwed together with the planetary bolt 101, but rather, with the planetary carrier 115. Correspondingly, the thread pair 111 is formed by an external thread on the axial fixing means 109 and an internal thread of the planetary carrier 115. Such a design of the axial fixing means 109 allows a comparatively straight load path between the planetary bolt 101 and the thread pair 111. This has corresponding advantages regarding the load-bearing capacity of the axial fixing means 109.

The locking screws 121 shown in FIG. 4 act on the planetary bolt 101. The axial fixing 109 against rotation relative to the planetary carrier 115 is only ensured if the planetary bolt 101 can be fitted in the planetary carrier 115 in a rotationally fixed manner.

On the other hand, if rotation of the planetary bolt 101 relative to the planetary carrier 115 cannot be excluded, the locking screws 121 can alternatively be arranged so that they act against the planetary carrier 115. Despite a rotation of the planetary bolt 101 relative to the planetary carrier 115, in this way rotation of the axial fixing means 109 relative to the planetary carrier 115 and hence loss of the tensioning or the desired axial play of the planetary bearings can be prevented.

Alternatively, the locking screws 121 need not be used if the axial fixing means 109 are designed as a locknut with a corresponding securing means fitted on the planetary carrier 115.

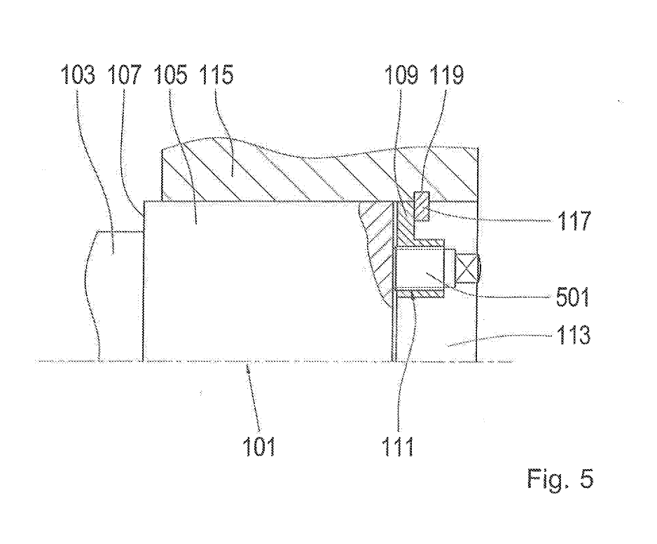

FIG. 5 shows an axial fixing means 109 with an internal thread. This is not screwed together with the planetary bolt 101, but forms the thread pair 111 with the external thread of a screw 501. The screw 501 is arranged so that it can exert a force on the planetary bolt 101 which results in tensioning of the planetary bearings, or fixes the planetary bolt 101 axially in such manner that a desired bearing play is produced.

To secure the screw 501 against rotation, a locking screw 121—not shown in FIG. 5—can be provided, which is so arranged that it acts upon the screw 501. In particular, the locking screw 121 could be screwed into the axial fixing means 109 in the radial direction from the inside outward.

In the example embodiment shown in FIG. 5, in contrast to the above the screw 501 has a head which can be braced against the axial fixing means 109. This secures the screw 501 against rotation.

### INDEXES

101 Planetary bolt
103 First section
105 Second section
107 Shoulder
109 Axial fixing means
111 Matching thread pair
113 Recess
115 Planetary carrier
117 Locking ring
119 Groove
121 Locking screw
501 Screw

1-7. (canceled)

8. A planetary bolt (101) comprising:
a first section (103) of the planetary bolt (101) being designed to receive planetary bearings,
a second section of the planetary bolt (101) having a shoulder (107) for at least one of axially fixing and tensioning the planetary bearings, and
at least one of:
at least one internal thread, and the second section (105) of the planetary bolt (101) having a run-in opening of the internal thread; and
at least one external thread with the external thread being on the second section (105) of the planetary bolt (101).

9. The planetary bolt (101) according to claim 8, further comprising means (109) for at least one of axially fixing and tensioning of the planetary bolt (101) and the means having at least one thread which can be screwed together with one of the internal thread or the external thread of the planetary bolt.

10. The planetary bolt (101) according to claim 8, wherein the means (109) is braced against either a locking ring or a lamellar ring (117) when the locking ring or the lamellar ring (117) is set into a groove (119) in a planetary carrier (115).

11. A planetary carrier (115) with at least one through-going bore (113) for introducing and fixing a planetary bolt (101), and the through-going bore (113) has an internal thread.

12. The planetary carrier (115) with at least one through-going bore (113) for introducing and fixing the planetary bolt (101) according to claim 11, further comprising means (109) for at least one of axially fixing and tensioning of the planetary bolt (101) in the planetary carrier (115), and the means has at least one external thread which is screwed into the internal thread of the planetary carrier (115).

13. A means (109) for at least one of axially fixing and tensioning of a planetary bolt (101), the means comprising:
at least one internal thread such that:
by screwing a screw (501) into the internal thread, the screw (501) is braced against the planetary bolt (101); and
by screwing the screw (501) into the internal thread, the means (109) is braced against either a locking ring or a lamellar ring (117) when the locking ring or the lamellar ring (117) is set into a groove (119) in a planetary carrier (115).

14. The planetary bolt (101) according to claim 8, wherein the means (109) has at least one through-going thread, into which a locking screw (121) is insertable, such that the locking screw (121) prevents any rotation of the means (109) relative to at least one of the planetary bolt (101) and the planetary carrier (115).
